(19) United States
(12) Patent Application Publication
(10) Pub. No.: US 2023/0368123 A1
(43) Pub. Date: Nov. 16, 2023

(54) AUGMENTED REALITY DISPLAY OF LOCATION BASED CONTRACTING

(71) Applicant: DriverDo LLC, Overland Park, KS (US)

(72) Inventor: Mashhur Zarif Haque, Lawrence, KS (US)

(21) Appl. No.: 18/315,058

(22) Filed: May 10, 2023

Related U.S. Application Data
(60) Provisional application No. 63/340,086, filed on May 10, 2022.

(51) Int. Cl. G06Q 10/0834; G06T 11/00; G01C 21/36

(52) U.S. Cl. CPC G06Q 10/0834; G01C 21/3614; G01C 21/3682; G06T 11/00

(57) ABSTRACT

A system for displaying mobile contracting information by augmented reality, in some embodiments, includes a mobile device, a vehicle information system, a camera, and a heads-up display. The mobile device may be configured to display mobile contract task information in conjunction with the heads-up display. The heads-up display, mobile device, and vehicle display may be configured to display, in augmented reality, mobile contract task information inserted into an environment view captured by the camera. The system may receive a mobile contract and present mobile contract information to a user for rejection or acceptance. The system may display, in augmented reality, mobile contract navigation instructions to the user, a mobile contract location highlight indicating the mobile contract location, and any other contracting information with an augmented view and/or over a map.

### RELATED APPLICATIONS

This non-provisional application claims the benefit of priority from U.S. Provisional Application Ser. No. 63/340,086, filed May 5, 2022, entitled “AUGMENTED REALITY DISPLAY OF LOCATION BASED CONTRACTING.”

### BACKGROUND

### 1. Field

Embodiments of the present disclosure relate to mobile contracting and location visualization. Specifically, embodiments of the present disclosure relate to mobile work contracting and displaying contracting and location information by augmented reality.

### 2. Related Art

There are various types of pickup and delivery services performed across a plurality of industries. There are vehicle transportation services, parcel delivery services, food delivery services and the like. Typically, within these industries, a user will receive information indicative of a task to be performed as well as task location information. The user will drive, ride, or walk to the location and perform the task. These tasks may be given to the user at a work location or via a communication device such as a mobile device.

Typically, for the user to find the work location, when the task location information is provided to the user, the user must enter the location information into a map application and receive directions from the user’s location to the task location by the mobile device or a vehicle GPS service. The user must then travel to the task location and find the address of the task location on the building or house. The address of the task location is not always easily viewed, and this process may result in a delay of performing the task.

Furthermore, when the user locates the task location, the user may have to review the contract on papers or on a mobile device to find the instructions for performing the task. Driving, finding the task location, parking, and looking through task instructions can be a cumbersome task that requires multi-tasking and can result in delays.

What is needed is an integrated system that displays contracts, instructions, and task location in an augmented reality environment to reduce the burden on the user and reduce delays.

### SUMMARY

In some aspects, the techniques described herein relate to a method for providing mobile contracting information by augmented reality. The method includes receiving an offer to perform a mobile contract task, displaying, by a mobile device, first information indicative of the mobile contract task, displaying, by the mobile device, second information indicative of a mobile contract task location, wherein the mobile device is communicatively coupled to at least one processor of a vehicle, receiving video data from at least one camera associated with the vehicle, displaying, by a vehicle heads-up display, the first information indicative of the mobile contract task integrated with the video data; and receiving, from a user, input indicating acceptance to perform the mobile contract task.

In some aspects, the techniques described herein relate to the method, further including displaying, by a map on a display of the vehicle or the mobile device, navigation directions associated with the mobile contract task.

In some aspects, the techniques described herein relate to the method, wherein the navigation directions are displayed with the video data by the vehicle heads-up display.

In some aspects, the techniques described herein relate to the method, further including displaying, on the vehicle heads-up display, an icon indicative of the mobile contract task.

In some aspects, the techniques described herein relate to the method, further including displaying, on the vehicle heads-up display, a task description indicative of the mobile contract task.

In some aspects, the techniques described herein relate to the method, wherein the icon and the task description are integrated with the video data in augmented reality.

In some aspects, the techniques described herein relate to one or more non-transitory computer-readable media including computer-executable instructions that, when executed by at least one processor, perform a method of providing mobile contracting information by augmented reality, The method includes receiving an offer to complete a mobile contract task, causing display of, on a vehicle heads-up display of a vehicle, first information indicative of the mobile contract task, causing display of, on the vehicle heads-up display, second information indicative of a mobile contract task location, receiving, from a camera, video data, causing display of the first information indicative of the mobile contract task integrated with the video data, and receiving, from a user, input indicating acceptance of the mobile contract task.

In some aspects, the techniques described herein relate to the method, further including causing display of navigation directions associated with the mobile contract task, by a map with the video data.

In some aspects, the techniques described herein relate to the method, further including causing display of, on a mobile device communicatively coupled to at least one vehicle processor of the vehicle, an icon indicative of the mobile contract task with the video data.

In some aspects, the techniques described herein relate to the method, further including causing, on the mobile device, a task description indicative of the mobile contract task with the video data.

In some aspects, the techniques described herein relate to the method, further including causing display of, on the mobile device, a plurality of volumetric 3D objects indicative of the navigation directions.

In some aspects, the techniques described herein relate to the method, further including causing display of, on the mobile device, a highlight indicating the mobile contract task location.

In some aspects, the techniques described herein relate to the method, wherein the mobile contract task location is highlighted by at least one of the plurality of volumetric 3D objects.

In some aspects, the techniques described herein relate to the method, further including receiving, from the user, further input indicating completion of the mobile contract task.

In some aspects, the techniques described herein relate to a system for providing mobile contracting information by augmented reality, The system includes at least one processor, a camera, communicatively connected to the at least one processor, the camera configured to capture video data, a mobile device, communicatively connected to the at least one processor, the mobile device receiving user input and displaying information indicative of a mobile contract task, and a vehicle heads-up display (HUD), communicatively connected to the at least one processor, the vehicle HUD configured to display the video data.

In some aspects, the techniques described herein relate to the system, further including a sensor, communicatively connected to the at least one processor, the sensor configured to capture environment information associated with the video data.

In some aspects, the techniques described herein relate to the system, wherein the vehicle HUD displays, by augmented reality, the information indicative of the mobile contract task with the video data.

In some aspects, the techniques described herein relate to the system, wherein the vehicle HUD displays, by augmented reality, further information indicative of a mobile contract task location with the video data.

In some aspects, the techniques described herein relate to the system, wherein the information indicative of the mobile contract task location includes an icon indicative of the mobile contract task location.

In some aspects, the techniques described herein relate to the system, wherein the information indicative of the mobile contract task includes a task description indicative of the mobile contract task.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE FIGURES

Embodiments of the invention are described in detail below with reference to the attached drawing figures, wherein:

FIG. 1 depicts an exemplary hardware platform that can form one element of certain embodiments of the disclosure;

FIG. 2 depicts a mobile device and heads-up display, displaying mobile contract information on a screen and in augmented reality;

FIG. 3 depicts an exemplary system for receiving task information and displaying location information by augmented reality;

FIG. 4A depicts an exemplary embodiment of the elements of the system for receiving task information and displaying location information by augmented reality, connected using hardline wiring;

FIG. 4B depicts an exemplary embodiment of the elements of the system for receiving task information and displaying location information by augmented reality, connected using a wireless local network; and

FIG. 5 depicts an exemplary method for receiving task information and displaying the location by augmented reality.

The drawing figures do not limit the disclosure to the specific embodiments disclosed and described herein. The drawings are not necessarily to scale, emphasis instead being placed upon clearly illustrating the principles of the disclosure.

### DETAILED DESCRIPTION

Embodiments of the present disclosure provide systems, methods, and programs for receiving instructions for a task to be performed, providing a user of the system to view the instructions for the task and task location information, and accept or reject the task. Furthermore, the application may integrate with other applications and sensors on a mobile device or a peripheral device and provide task information and location information in an augmented reality visualization. The user may view all information related to the task on a screen providing location information by a map, an image, or by a live feed from a camera associated with the mobile device or the peripheral device.

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

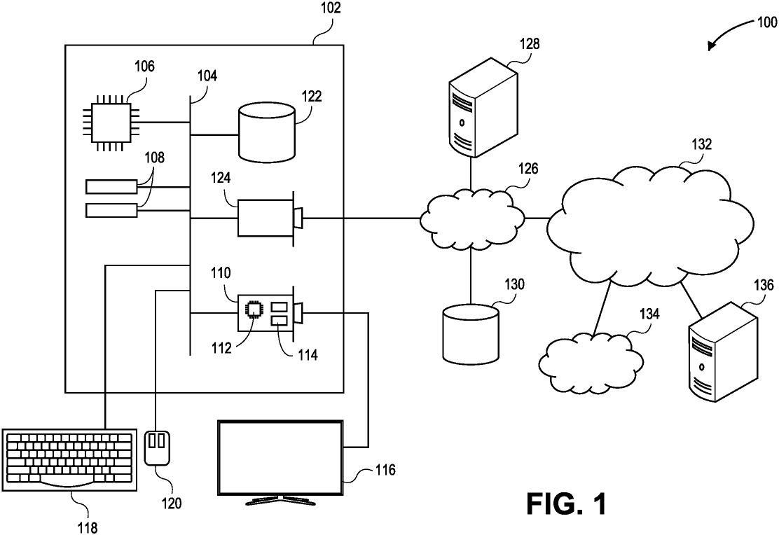

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is a processor or central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of non-transitory computer-readable media and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

In some embodiments, the application may run on a computer or mobile device or be accessed via the computer or the mobile device and run in a web-based environment from the recipient’s web browser and may provide the embodiments described herein. The web-based environment may store data such that it is not required for the computer 102 to have downloaded and stored large amounts of data for the application. The application may access data such as object databases, user profiles, third party vendors, or any other online service or website that is available over Internet 132.

Generally, systems, methods, and programs may provide services for receiving contract offers, accepting contract offers, and displaying contract and location information by augmented reality. The services may be provided to a user receiving and accepting the contract offers by any communication device and the augmented reality may be displayed by receiving media from cameras or map data and displaying contract and location information with the media. In some embodiments, the location of the user may be determined and used to select which users receive the contract offer. The augmented reality view of the contract offer may be displayed to the user prior to the user accepting the offer. As such, the users that are closest and that have the highest likelihood of accepting the offer may be pushed the offers first. Furthermore, displaying a visualization of the contract (e.g., pickup/delivery) that is on the user’s route for performing tasks may further entice the user to accept and fulfill the contract.

In some embodiments, a user may be any person with a profile associated with an application stored on, or accessible by, computer 102. In some embodiments, computer 102 may be a mobile device or a peripheral device, such as a vehicle communication system connected to the mobile device. The user may receive information indicative of tasks to be performed and the user may accept or deny the task requests. Furthermore, the information indicative of the task to be performed may include a location of the task and a description of the task as well as other users offered, a contracting company, or any other information that may be associated with the task.

In some embodiments, the application may be accessible by the mobile device and may integrate with other device applications to provide notifications and other services. For example, in some embodiments, when a task offer is received, a map displaying the location of the task to be performed may be opened by the user or may automatically open. In some embodiments, the map may be automatically opened, and the task information may be displayed over the map in an augmented reality view.

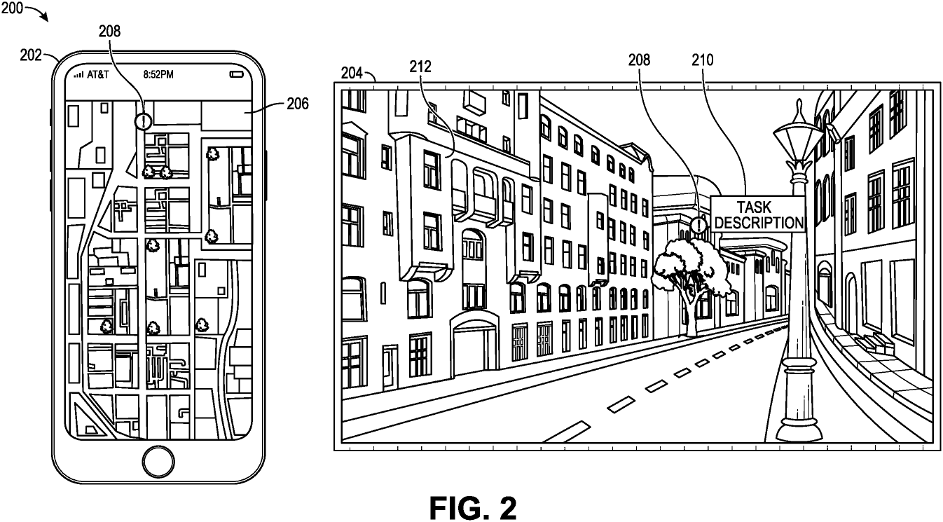

FIG. 2 depicts exemplary devices 200 for carrying out embodiments of the present disclosure. The exemplary devices 200 may be mobile device 202 and heads-up display 204 presenting visualizations associated with a task application. In some embodiments, an offer for a task to be performed may be received by the task application associated with mobile device 202. The offer may comprise information indicative of the task to be performed such as, for example, contract information, contractor information, location information, special requests, and any other information that may be necessary for the user to perform the task. In some embodiments, as described herein, the task application may be any application stored on, or accessible by, a mobile device, a computer, or a vehicle computer associated with, or part of, system 400.

In some embodiments, the user may carry mobile device 202 as the user performs the task. Mobile device 202 may include a camera configured to capture photo and video. In some embodiments, the camera device may be configured to capture 360° video. Mobile device 202 may capture environment view 212 from a live video feed from camera integrated into the device. Environment view 212 may be adapted into an augmented reality view by inserting task description 210 and icon 208 into environment view 212.

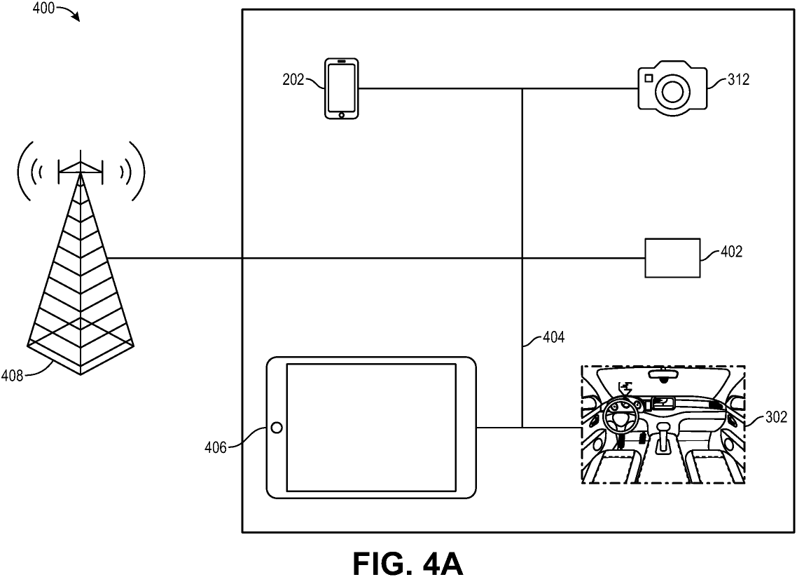

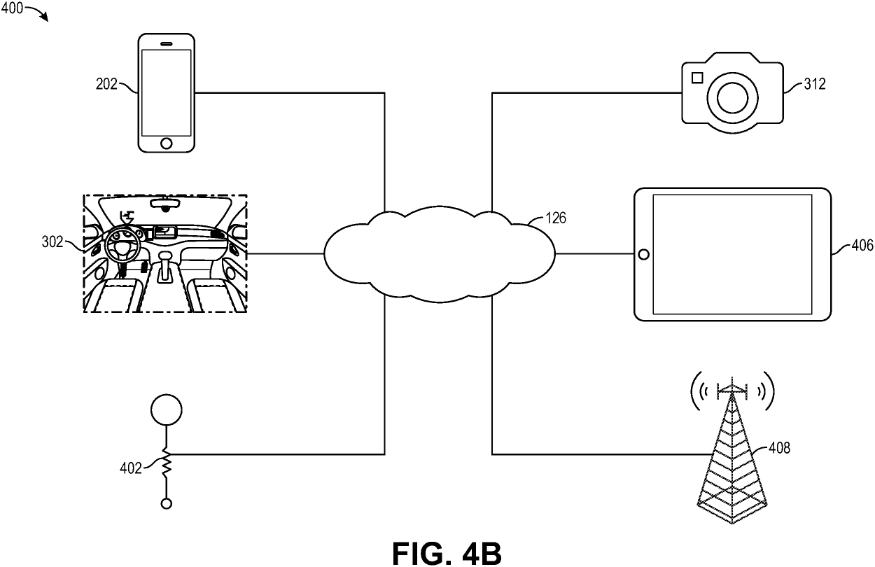

Mobile device 202 may comprise any mobile computing device such as a laptop computer, a cellphone, a tablet, an MP3 player with wireless capability, a vehicle computer system, a GPS addon device, a tablet computer, a tablet, etc. or mobile device 202 may be integrated into a computer system present in a vehicle such as a motorcycle, a car, a truck, a tuk-tuk, etc. Further, system 400 (FIGS. 4A and 4B) may be integrated into non-motorized vehicles such as a bicycle, a tricycle, a scooter, etc., or system 400 may be implemented on a mobile device carried by a user on foot.

In some embodiments, one or more artificial intelligence algorithms may be employed by system 400 to direct the user through the environment. For example, the artificial intelligence (AI) may analyze the video feed and use image recognition, object recognition, text recognition, or any other form of image processing to analyze environment view 212 and determine a geolocation of the user. In some embodiments, the user may enter an area that is unfamiliar to system 400 and may be directed by the AI using task description 210 and icon 208. In some embodiments, the AI provides verbal directions indicating mobile contract navigation instructions.

In some embodiments, system 400 is implemented on a vehicle having self-driving functionality. The AI may gain control of the vehicle and follow the mobile contract navigation instructions to the location of the task. In some embodiments, the mobile contract navigation instructions may require the vehicle to be parked and the user to continue on foot to the location of the task. In such embodiments, the user may exit the vehicle, remove mobile device 202 from the vehicle, and continue to follow, on foot, while the mobile contract navigation directions are displayed in augmented reality on a screen of mobile device 202.

In some embodiments, the user may be an independent contractor or work for a company that sends the task request by system 100. For example, the user may be a vehicle transportation driver and may be contracted by vehicle rental companies to move vehicles between rental locations. The user’s location may be shared with the rental companies such that when a vehicle needs to be transported from a first location to a second location, the user’s information is shared with the rental company. The task request may be sent to the user based on the user’s relative location to the task to be performed (i.e., the vehicle pickup). Because the user is relatively close to the task location, the request may be sent directly to the user. Furthermore, in some embodiments, the user may work for a transportation company and the rental company may contact the transportation company and the transportation company may send the task request.

In some embodiments, a reputation of the user may be stored by system 400 such that the request may also be based on the reputation or rating. For example, more highly rated drivers may receive requests across larger areas than lower rated drivers. As such, lower rated drivers may receive fewer requests than more highly rated drivers. In some embodiments, requests may only be sent to users with ratings of a minimum threshold. For example, a request for pickup by an UBER driver may require a minimum rating. As such, any driver in the vicinity of the pickup with at least a minimum rating may receive the request while drivers below the minimum rating may not.

In some embodiments, when a request is received by the user, information indicative of the task may be displayed on mobile device 202. For example, the user may receive a notification by mobile device 202 indicating that a request for a task has been received. The request may then be displayed in text via email, direct message, or by a message interface on the application. In some embodiments, the request is displayed in augmented reality on heads-up display 204. Task description 210 and icon 208 may be adapted to display the request in augmented reality on heads-up display 204.

In some embodiments, the task application may integrate with other mobile applications stored on and accessible by system 400 including mobile device 202. For example, the task application may communicate with any location sensors and location applications, short range communication transmitters, receivers, and associated applications, and communications applications, such as, email, text messaging, and social media applications, as well as any other hardware components, peripheral devices, and applications necessary to provide the functionality described herein.

In some embodiments, the task application may access a GPS location of the user and provide the task request based on the location. For example, the location of the user may be within a set geographical threshold distance of the task location. Therefore, based on the relative location, the user may receive the task request. In some embodiments, the relative location threshold may be customizable by the contracting company and may apply to specified drivers as described above.

In some embodiments, the task location information may be displayed by any application for presenting map 206 as depicted on mobile device 202 depicted in FIG. 2. Map 206 may be displayed as any graphical representation of the geographic environment including satellite imagery, camera images, illustrations, and real-time video data collected from an associated camera.

In some embodiments, system 400 may obtain the map data and display any task information over the map data in an augmented reality visualization. For example, icon 208 may be displayed over the task location displayed on map 206. This provides the user an easy to view visualization of the user’s location relative to the location of the task. Furthermore, in some embodiments, directions, and travel time information from the location of the user to the location of the task may be displayed such that the user may evaluate whether the user would like to accept the task.

In some embodiments, task information may be displayed along with icon 208 such that the user may have all task information in one visualization. As shown in FIG. 2 task description 210 displays information associated with the task. For example, task description 210 may comprise a description of the task to be completed, which may be provided along with special instructions such as, for example, “Deliver the package to Jane Doe at 123 Freeway Drive. Do not ring doorbell.” Task description 210 may display any information associated with a location of the task and any details associated with completion of the task including special instructions, cost, and whether payment has been processed or is to be collected by the user.

In some embodiments, task information may be displayed on environment view 212 by augmented reality and task description 210 and icon 208 may comprise volumetric 3D objects displayed on heads-up display 204. The volumetric 3D objects representing task description 210 and icon 208 may be integrated into environment view 212. In some embodiments, a task location may be highlighted using 3D volumetric objects such as an arrow, a chevron, a line, a pointing hand, a road sign, or any other 3D object configured to highlight an object or location.

In some embodiments, map 206 may be displayed on mobile device 202. Map 206 may include any icons and text as described herein. The task application may communicate with applications and sensors associated with map 206 and may communicate with any location and short-range communications sensors and applications on mobile device 202 as well as any peripheral device. In some embodiments, the task application may communicate with a camera on mobile device 202 or a peripheral device such as a communication system of a vehicle. In an exemplary embodiment, the user may be walking or biking and looking for a location by map 206. Icon 208 displaying the destination may be provided on map 206. Furthermore, the user’s location and directions from the user’s location to the destination may be displayed. The user may proceed to the destination based on the location information provided by map 206. When the user arrives at the destination, the user may access a camera option to display the surrounding environment. The surrounding environment may be shown by the camera of mobile device 202 and icon 208 and task description 210 may also be shown at the destination. As such, the user can easily see the destination with an indication on the image indicating the destination along with a description of the task to be performed at the destination. This may provide all of the information necessary for the user to complete the task in a single augmented reality location.

In some embodiments, map 206 may be displayed by heads-up display 204 communicating with mobile device 202 to show icon 208 and task description 210. As described above, map 206 may display route information as well as icon 208 and task description 210 such that the user has all necessary information displayed on a single page. Furthermore, map 206 may switch to an environment view provided by the associated camera (e.g., camera 312) and icon 208 and task description 210 may be displayed in the environment view.

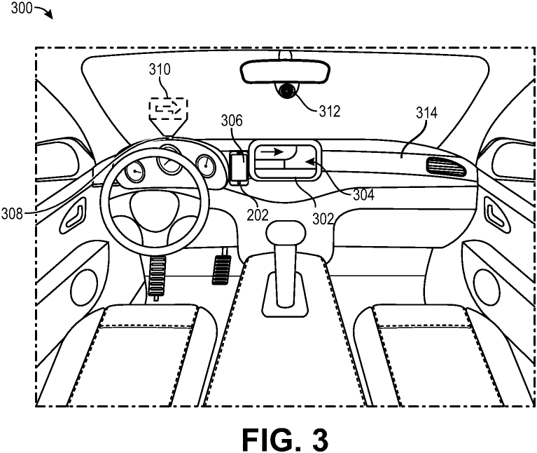

In some embodiments, video and image data from one or more cameras (camera 312, FIG. 3) associated with the vehicle may be displayed on heads-up display 204. The application on mobile device 202 may communicate with the vehicle communication system and display icon 208 and task description 210 on the video and image data displayed on heads-up display 204. In some embodiments, the vehicle computer system may store or access the application. As such, the vehicle computer system may be system 100 and it may not be necessary to communicate with mobile device 202. The user may interact with the task application directly through heads-up display 204.

Information displayed by mobile device 202, heads-up display 204, or any other peripheral device may be any information indicative of the task such as, for example, icons such as arrows, circles, exclamation points, emojis, text, and any other icon that may be displayed. In some embodiments, text describing the task or special remarks may be displayed such as, for example, “drop package off at garage,” “knock,” “do not ring doorbell,” or the like. Any information that may assist the user in identifying the location for the task and performing the task may be displayed.

In some embodiments, the information displayed may be obtained from communication via the application or associated communication applications such, for example, email, text message, and social media. The user may communicate with the employer, contractor, or recipient and the communications may be displayed by task description overlaid on map or the displayed environment.

In some embodiments, the application may be used with any location-based tasks. For example, a paper carrier, mail carrier, or parcel delivery person may use the application in route to drop off locations. Vehicle delivery persons may use the application for contracting vehicle transfers from location to location. In some embodiments, the application may be used in taxi services such as, for example, UBER, LYFT, or CURB, or in food delivery services such as, for example, DOORDASH or UBEREATS. In embodiments described herein, the application may be used for receiving a task and performing the task while providing location and task description information in augmented reality.

FIG. 3 depicts an exemplary use case of system 400 for receiving task information and displaying location information by augmented reality generally referenced by numeral 300. A vehicle information system 302 is depicted integrated into a vehicle dashboard 314. Vehicle information system 302 may display navigational information on display screen 304. Vehicle information system 302 may include a 7-segment display configured to provide informational readouts. In some embodiments, display screen 304 is absent and navigational information is displayed in text form on a 7-segment display. In some embodiments, vehicle information system 302 includes an input/output port for direct connection to mobile device 202. Mobile device 202 may be configured to display an augmented reality view of environment view 212 captured by camera 312. In some embodiments, camera 312 may be integrated into mobile device 202. Mobile device 202 may display task information and/or instructions on display screen 306. In some embodiments, mobile device 202 is communicatively connected to heads-up display 308. Heads-up display 310 may receive navigation information from mobile device 202, or alternatively, vehicle information system 302.

In some embodiments, heads-up display 310 provides an augmented reality display of navigational information associated with task information (e.g., task description 210). Heads-up display 310 may include augmented reality instructions associated with the mobile contract task, navigational directions associated with the mobile contract task, update information associated with the mobile contract task, location updates associated with the mobile contract task, driver performance statistics or any other relevant information associated with the mobile contract task.

In some embodiments, camera 312 is a dashcam integrated into the vehicle. Camera 312 may be an external camera present on the exterior of the vehicle. In some embodiments, camera 312 is placed on or integrated into vehicle dashboard 314. Camera 312 may be an infrared camera, a digital single-lens reflex (DSLR) camera, a camera-phone, a webcam, or any other form of video capturing device present or future.

In some embodiments, system 400, depicted in FIGS. 4A and 4B, provides mobile contracting and task information to mobile contractors such as UBER drivers, DoorDash drivers, Lyft drivers, UBEREATS drivers, DRAIVER drivers, GrubHub drivers, Instacart drivers, Postmates drivers, or any other mobile contractor present or future. System 400 may apply facial recognition such that one or all of the devices integrated into system 400 are capable of using facial recognition algorithms to process a live video feed captured by camera 312. In such an embodiment, system 400 may use facial recognition to locate a rideshare passenger in the live video feed. When such a passenger is located, system 400 may apply the facial recognition algorithm to the augmented reality view to highlight the rideshare passenger in the live video feed. The highlight may be accomplished using an icon, an illuminated silhouette, plain text, an animated graphic, a volumetric 3D object, or any other graphic representation present or future. In some embodiments, task description 210 and icon 208 are adapted to highlight the rideshare passenger. The live video feed and highlight may be displayed by display screen 304 on heads-up display 310, or by display screen 306.

In some embodiments, a food delivery mobile contractor such as a DoorDash driver is provided mobile contracting information and task information by system 400. Camera 312 is programmed to use object recognition algorithms to process a live video feed captured by camera 312. In such an embodiment, camera 312 may use object recognition algorithms to locate delivery pickup locations in the live video feed. System 400 may then apply the object recognition algorithm to the augmented reality view to highlight the delivery pickup location. The highlight may comprise an icon, an illuminated silhouette, plain text, an animated graphic, a volumetric 3D object, or any other graphic representation present or future. In some embodiments, task description 210 and icon 208 are adapted to highlight the delivery pickup location. The live video feed and highlight may be displayed by display screen 304, by heads-up display 310, or by display screen 306.

Turning now to FIG. 4A, an exemplary arrangement of the system 400 for receiving task information and displaying location information by augmented reality is generally referenced by numeral. In such an embodiment, mobile device 202, camera 312, sensor 402, vehicle information system 302, and tablet 406, are communicatively connected to each other. For example, each of these devices may transmit or receive data using the Universal Serial Bus (USB) standard, the Universal Asynchronous (Synchronous) Receiver Transmitter (UART/USART) standard, Recommended Standard 232 (RS-232), Recommended Standard 485 (RS-485), Inter-Integrated Circuit Bus (I2C) standard, Serial Peripheral Interface (SPI), or any other local communication standard present or future. All of the devices in system 400 may be connected by internal network 404 which may employ any communication standard as previously discussed.

In some embodiments, internal network 404 and all connected devices may be connected to wireless network 408. In some embodiments, wireless network 408 may communicate with a wirelessly connected server to transmit task information, task location information, and any other information relevant to the current task. In some embodiments, internal network includes a wireless receiver/transmitter combination for communication with external devices and networks. In some embodiments, the internal network 404 uses a wireless receiver/transmitter integrated into mobile device 202 to communicate with external devices and networks. Each device connected to internal network 404 may include a wireless receiver/transmitter to communicate with a wireless network.

FIG. 4B depicts an exemplary embodiment of system 400 as a wirelessly connected network. Mobile device 202 may be wirelessly connected to local network 126. Mobile device 202 may wirelessly transmit to local network 126 or wireless receive from local network 126: task information, task location information, augmented reality information, 3D imaging information, driver analytics information, payment information, driver tracking information, or any other information relevant to the driver, task, vehicle, or environment. Vehicle information system 302 may be wirelessly connected to local network 126. Vehicle information system 302 may wirelessly transmit or receive any or all of the information wirelessly transmitted or received by mobile device 202 or any other device wirelessly connected to local network 126.

Tablet 406 may be wirelessly connected to local network 126. Tablet 406 may transmit or receive any or all of the information wirelessly transmitted or received by mobile device 202 or any other device connected to local network 126. In some embodiments, tablet 406 displays task location information and task instructions. In some embodiments, mobile device 202 is not present and tablet 406 replaces mobile device 202′s functionality. In some embodiments, mobile device 202, tablet 406, and vehicle information system are all present and wirelessly connected to local network 126. In such an embodiment, mobile device 202, tablet 406, and vehicle information system 302 transmit and receive to or from each other any or all information discussed above.

System 400 may be connected to wireless network 408. System 400 may include a wireless transmitter/receiver to communicate with wireless network 408. System 400 may transmit and receive information to and from wireless network 408. In some embodiments, system 400 uses a wireless transmitter/receiver integrated into mobile device 202. Mobile device 202 may transmit all information transferred by each device connected to local network 126. In some embodiments, mobile device 202, tablet 406, camera 312, vehicle information system 302, and any other devices connected to local network 126, are connected via Bluetooth. System 400 may transmit or receive mobile contracting information to and from wireless network 408 by a wireless transmitter/receiver connected via Bluetooth to local network 126.

In some embodiments, camera 312 is wirelessly connected to local network 126. Camera 312 may transmit a live video feed through local network 126 to each other device connected to local network 126. In some embodiments, the live video feed is processed on camera 312. In some embodiments, the live video feed is processed externally on another device connected to local network 126. In some embodiments, a server connected to local network 126 processes the live video feed and transmits the processed video feed to each device connected to local network 126.

Sensor 402 may be wirelessly connected to local network 126. Sensor 402 may receive information regarding its environment. In some embodiments, sensor 402 is a light detection and ranging (LiDAR) sensor. In some such embodiments, sensor 402 may generate three dimensional (3D) mappings of the sensor’s environment. Camera 312 and sensor 402 may function together to create a three dimensionally mapped video feed of camera 312 and sensor 402′s environment. In some embodiments, the three dimensionally mapped video feed is used to generate an augmented reality view.

Camera 312 may capture data used by image recognition algorithms to interpret the live video feed recorded by camera 312. System 400 may use image recognition algorithms to recognize road signs, street numbers and names to determine a location of the vehicle. Camera 312 may transmit the interpreted live video feed through local network 126. In some embodiments, an external device such as mobile device 202 or tablet 406 may be programmed to use image recognition algorithms to interpret the live video feed recorded by camera 312. In some embodiments, camera 312 uses an image recognition algorithm to process the live video feed and a second device runs a redundant image recognition algorithm for error correction.

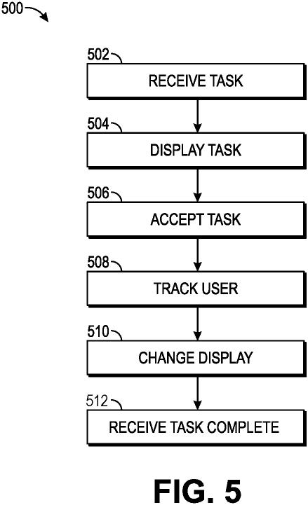

FIG. 5 depicts an exemplary process for receiving task information and displaying the location by augmented reality generally referenced by numeral 500. At step 502, the user may receive information associated with the task that needs completed. In some embodiments, the task may be sent to the user based on the user’s location. For example, the user may operate within a specific jurisdiction, or the detected location of the user may be within a proximity to the location of the task. Therefore, the task may be either sent to the user for completion or offered to the user. In some embodiments, the task may be sent to the user based on an optimization of a route of the user. A user may be passing near the task location while performing a different task, therefore, the task may be provided to the user based on the user’s future location.

In some embodiments, the task may be provided to a plurality of users. In some embodiments, the plurality of user’s may be performing tasks. The task may be provided to the plurality of users within a specific area or within a specified distance of the task location. In some embodiments, the offers may be optimized by including user ratings and user future locations. Some users may be filtered out based on ratings as described above.

At step 504, the task may be displayed to the user. The task may be transmitted via the application or by any text message, email, or social media. The task may be displayed to the user including location information and task description information. In some embodiments, the task location may be displayed on map 206 or environment view 212 depicting the location. In some embodiments, icon 208 and task description 210 may be displayed on map 206 and environment view 212 in an augmented reality depiction.

At step 506, the user may accept the task. The user may accept the task by selecting an accept control or responding to the contractor. The task application may register the task as accepted by the user such that the task is removed from suggesting to other users. In some embodiments, the accept control is displayed on heads-up display 204 with the live video feed captured by camera 312.

At step 508, the task application may communicate with an application, the application presenting map 206 to track the location of the user. Map 206 may provide directions from the user location to the task location. Map 206 may also display icon 208 and task description 210. In some embodiments, the location of the user may be transmitted to a separate user that requested completion of a mobile contract task. In some embodiments, the location of the user may be stored and analyzed to determine user performance and efficiency in completing mobile contract tasks.

At step 510, the user may change the display between environment view 212 and task description 210 using icon 208, with the environment view enhanced by augmented reality. In some embodiments, the display may display map 206 or environment view 212 by interfacing with the camera of mobile device 202 or the vehicle. Icon 208 and task description 210 may be displayed on a map present on mobile device 202 and environment view 212 providing the user all necessary information to complete the task in a single location.

At step 512, the application may receive a task complete indication and mark as completed. The task complete indication may be input by the user or may be received by the user taking a picture of the completed task and submitting the picture or by the recipient indicating that the task is complete. In some embodiments, the user may scan an indicium of a package or location providing the necessary information that the task has been completed and the task may be automatically registered as complete.

In some embodiments, camera 312 applies an image recognition algorithm to determine if the mobile contract task is complete. In such an embodiment, when the mobile contract task is confirmed to be complete, indication of the mobile contract task’s completion may be transmitted to the recipient or the mobile contracting service.

In some embodiments, computer 102 contains one or more computer-readable media containing computer-executable instructions that, when executed by CPU 106, perform the method described above in FIG. 5. In some embodiments, the computer-executable instructions cause the display of augmented reality information including information regarding mobile contract task information, mobile contract task location information, and any other relevant mobile contract information.

Although the current disclosure has been described with reference to the embodiments illustrated in the attached drawing figures, it is noted that equivalents may be employed, and substitutions made herein without departing from the scope of the invention.

Having thus described various embodiments, what is claimed as new and desired to be protected by Letters Patent includes the following.

1. A method for providing mobile contracting information by augmented reality, the method comprising:
receiving an offer to perform a mobile contract task;
displaying, by a mobile device, first information indicative of the mobile contract task;
displaying, by the mobile device, second information indicative of a mobile contract task location,
wherein the mobile device is communicatively coupled to at least one processor of a vehicle;
receiving video data from at least one camera associated with the vehicle;
displaying, by a vehicle heads-up display, the first information indicative of the mobile contract task integrated with the video data; and
receiving, from a user, input indicating acceptance to perform the mobile contract task.

2. The method of claim 1, further comprising displaying, by a map on a display of the vehicle or the mobile device, navigation directions associated with the mobile contract task.

3. The method of claim 2, wherein the navigation directions are displayed with the video data by the vehicle heads-up display.

4. The method of claim 1, further comprising displaying, on the vehicle heads-up display, an icon indicative of the mobile contract task.

5. The method of claim 4, further comprising displaying, on the vehicle heads-up display, a task description indicative of the mobile contract task.

6. The method of claim 5, wherein the icon and the task description are integrated with the video data in augmented reality.

7. One or more non-transitory computer-readable media comprising computer-executable instructions that, when executed by at least one processor, perform a method of providing mobile contracting information by augmented reality, the method comprising:
receiving an offer to complete a mobile contract task;
causing display of, on a vehicle heads-up display of a vehicle, first information indicative of the mobile contract task;
causing display of, on the vehicle heads-up display, second information indicative of a mobile contract task location;
receiving, from a camera, video data;
causing display of the first information indicative of the mobile contract task integrated with the video data; and
receiving, from a user, input indicating acceptance of the mobile contract task.

8. The method of claim 7, further comprising causing display of navigation directions associated with the mobile contract task, by a map with the video data.

9. The method of claim 8, further comprising causing display of, on a mobile device communicatively coupled to at least one vehicle processor of the vehicle, an icon indicative of the mobile contract task with the video data.

10. The method of claim 9, further comprising causing, on the mobile device, a task description indicative of the mobile contract task with the video data.

11. The method of claim 10, further comprising causing display of, on the mobile device, a plurality of volumetric 3D objects indicative of the navigation directions.

12. The method of claim 11, further comprising causing display of, on the mobile device, a highlight indicating the mobile contract task location.

13. The method of claim 12, wherein the mobile contract task location is highlighted by at least one of the plurality of volumetric 3D objects.

14. The method of claim 7, further comprising receiving, from the user, further input indicating completion of the mobile contract task.

15. A system for providing mobile contracting information by augmented reality, the system comprising:
at least one processor;
a camera, communicatively connected to the at least one processor, the camera configured to capture video data;
a mobile device, communicatively connected to the at least one processor, the mobile device receiving user input and displaying information indicative of a mobile contract task; and
a vehicle heads-up display (HUD), communicatively connected to the at least one processor, the vehicle HUD configured to display the video data.

16. The system of claim 15, further comprising a sensor, communicatively connected to the at least one processor, the sensor configured to capture environment information associated with the video data.

17. The system of claim 15, wherein the vehicle HUD displays, by augmented reality, the information indicative of the mobile contract task with the video data.

18. The system of claim 17, wherein the vehicle HUD displays, by augmented reality, further information indicative of a mobile contract task location with the video data.

19. The system of claim 18, wherein the information indicative of the mobile contract task location includes an icon indicative of the mobile contract task location.

20. The system of claim 19, wherein the information indicative of the mobile contract task includes a task description indicative of the mobile contract task.
